(19) United States
(12) Patent Application Publication
(10) Pub. No.: US 2010/0057557 A1
(43) Pub. Date: Mar. 4, 2010

(54) METHOD OF MANAGING A SHOPPING MALL SITE

(76) Inventor: Kun Sik Yoo, Seoul (KR)

Correspondence Address: GWIPS;Peter T. Kwon, Gwacheon P.O. Box 72, 119 Byeolyang Ro, Gwacheon City, Gyeonggi-Do, 427-600, KR

(21) Appl. No.: 12/450,916

(22) PCT Filed: May 1, 2008
(86) PCT No.: PCT/KR2008/002487

§ 371 Date: Oct. 19, 2009

(30) Foreign Application Priority Data
May 1, 2007 (KR) 10-2007-0042326

(51) Int. Cl. G06Q 30/00; G06Q 10/00; G06Q 20/00

(52) U.S. Cl. 705/14.45; 705/400; 705/14.73; 705/27; 705/14.69

(57) ABSTRACT

A method of managing a shopping mall site. A variety of products are on sale over a network at the shopping mall site. The method is able to induce a buyer to purchase the product using a user created content (UCC). The method includes receiving information about a requester to register the requester as a marketer, registering the user created content with a shopping mall managing system, storing information about the marketer, the UCC, and the product when a request for product purchase is transmitted to a buyer terminal, and distributing and paying a fee of a obtained profit to the marketer.

### TECHNICAL FIELD

The present invention relates to a method of managing a shopping mall and, more particularly, to a method of managing a shopping mall site at which a variety of products are on sale over a network.

### BACKGROUND ART

With the development of the technologies of networks such as Internet and their related infrastructure, electronic commerce is broadly used. Electronic commerce can be defined in a narrow sense as the process of buying and selling products through electronic media named a computer and a network, as well as in a wide sense as the process of electronically transacting all the processes for consumer-to-consumer (C2C), business-to-consumer (B2C), and business-to-business (B2B) using a network (communication network). The media that make the electronic commerce possible can include a shopping mall site by way of one example.

The shopping mall site is a type of business(seller)-to-consumer electronic commerce, which is to embody brick-and-mortar business (retailer of the real world) in a virtual space (i.e. cyberspace). Any buyer gets access to the shopping mall site through a web browser, searches for a product which he/she wants to purchase, and then purchases a desired product. The product can be paid with a credit card, account transfer, cybercash, or the like.

The seller who manages the shopping mall site makes use of various methods on the network in order to advertise the products that are on sale at the shopping mall site. The most popular methods include a method of explaining a function and performance of the corresponding product in the shopping mall site, a method of outputting an advertising blurb to a predetermined area assigned by a portal site such as Yahoo or Naver, a method of outputting advertisement in a pop-up format at a variety of sites, and so on.

Meanwhile, recent methods are used to insert the advertisement into a startup or shutdown screen of user created content (UCC), and pay a predetermined amount of production cost or cybermoney to a UCC producer in return. The UCC has recently became popular, and refers to moving picture content, which is produced and published through various sites on the network by a user in person so as to allow many persons to frequently look at it.

However, as described above, the method of using the UCC has no feature except that the medium for advertising the products is merely converted from an ordinary web page to a moving picture called the UCC.

Moreover, although popular UCC is viewed by many persons, it is impossible to precisely analyze how much such viewing exerts direct effect on the product sale. As such, it is difficult to establish a continuous advertisement design.

Further, as described above, the method of simply using the UCC as the medium for advertising the products makes it impossible to lastingly use influence of the producer who produces the popular UCC. In other words, the conventional method is only_adapted to make efficient use of the UCC as the advertising medium in the case in which the UCC producer registers the UCC with a specific site (where the UCC can be carried as the advertising medium). As such, there are many restrictions on making efficient use of all pieces of UCC, which the producer who produces the popular UCC serves on various UCC preview sites over the networks, as the advertising media.

### DISCLOSURE

### Technical Problem

The present invention provides a method of managing a shopping mall site, capable of inducing a buyer to purchase a product using a user created content (UCC), and generating a purchase intention of the buyer to maximize marketing effects by more frequently exposing information about the product to potential buyers.

### Technical Solution

In order to achieve the above object, according to one aspect of the present invention, there is provided a method of managing a shopping mall site applied to a shopping mall servicing system. The method comprises the steps of: receiving, by a shopping mall managing system that manages the shopping mall site, information about a requester, who wants to advertise a product sold at the shopping mall site using user created content, to register the requester as a marketer; registering the user created content, which is produced by the marketer and is linked with the product sold at the shopping mall site, with the shopping mall managing system; storing, by the shopping mall managing system, information about the marketer, information about the user created content, and information about the product when a request is made to purchase the product linked with the user created content is transmitted to a buyer terminal; and when a profit is obtained by selling the product, distributing and paying, by the shopping mall managing system, a fee of the profit to the marketer using these pieces of information.

### ADVANTAGEOUS EFFECTS

According to the present invention as described above, the marketer produces many pieces of good UCC such that the UCC is selected for profit distribution by the buyer, so that more buyers can be induced to visit the shopping mall site. In other words, the quality of the UCC becomes better, and thus many potential buyers who want to look at the UCC can be induced to visit the shopping mall site.

Further, the buyer can read the good UCC, and select the marketer carrying the good UCC so as to purchase the product, so that the marketer receives reward and support in return of the labors producing the UCC. Thereby, a motive can be offered to both the UCC producer (marketer) and the buyer.

Further, the marketers carry recommendation of the product on various UCC preview sites, so that a chance to expose the information about the product is increased to improve the marketing effects.

Although exemplary embodiments of the present invention have been described for illustrative purposes, those skilled in the art will appreciate that various modifications, additions and substitutions are possible, without departing from the scope and spirit of the invention as disclosed in the accompanying claims.

### DESCRIPTION OF DRAWINGS

FIG. 1 illustrates the configuration of an embodiment of a shopping mall servicing system to which the present invention is applied.

FIG. 2 is a flowchart illustrating an embodiment for explaining a method of managing a shopping mall site according to the present invention.

FIGS. 3 through 6 illustrate various formats of a screen and a code applied to the present invention.

FIG. 7 is a detailed flowchart illustrating an embodiment of a marketer registering process applied to the present invention.

FIG. 8 is a detailed flowchart illustrating an embodiment of a user created content (UCC) registering process applied to the present invention.

FIG. 9 is a detailed flowchart illustrating an embodiment of a product purchasing process applied to the present invention.

FIG. 10 is a detailed flowchart illustrating an embodiment of a profit distributing process applied to the present invention.

### BEST MODE

Hereinafter, the present invention will be described in detail with reference to the accompanying drawings.

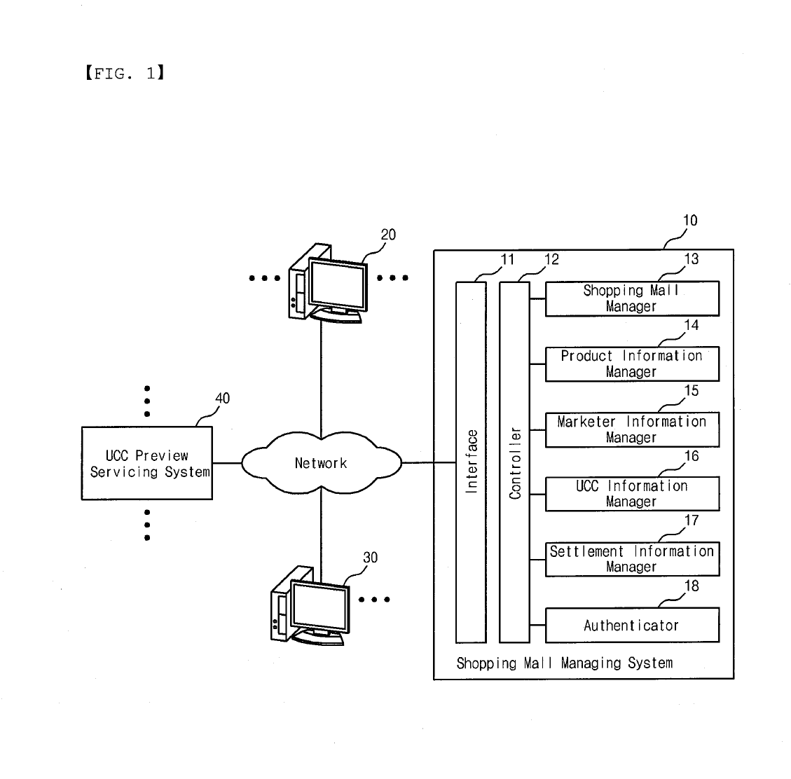

FIG. 1 illustrates the configuration of an embodiment of a shopping mall servicing system to which the present invention is applied.

As illustrated in FIG. 1 the shopping mall servicing system to which the present invention is applied comprises a shopping mall managing system 10 managed by a shopping mall manager (distributor), a marketer terminal 30 which a marketer registered with the shopping mall managing system makes use of to produce user created content (UCC), a UCC preview servicing system 40 which offers various pieces of UCC produced through the marketer terminal, and a buyer terminal 20 which is used by a buyer who accesses the shopping mall managing system or the UCC preview servicing system to examine various pieces of information about products. The terminals 20 and 30 and the systems 10 and 40 are connected with each other through a wired or wireless network such as a wired or wireless Internet.

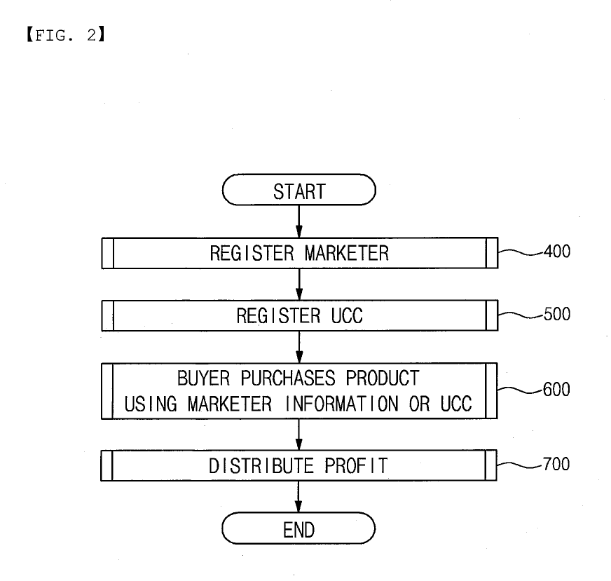

The shopping mall managing system 10 refers to a system that offers various pieces of product information through the network, and performs management in a manner such that information on settlement is processed when a purchase request is made by the buyer terminal 20, and then a requested product is delivered to a buyer. As illustrated in FIG. 1, the shopping mall managing system 10 includes an interface 11, a controller 12, a shopping mall manager 13, a product information manager 14, a marketer information manager 15, a UCC information manager 16, a settlement information manager 17, and an authenticator 18, and can be realized through various servers or high-performance personal computer (PC). The interface 11 functions to connect the shopping mall managing system 10 to the UCC preview servicing system 40, the buyer terminal 20, the marketer terminal 30, and so on by means of the network. The shopping mall manager 13 functions to manage a shopping mall site at which the products are intended to be on sale through the network. The product information manager 14 functions to manage information about various products that are on sale through the shopping mall site, and builds up a database of basic product codes of the various products. The marketer information manager 15 functions to manage information about marketers who produces various pieces of UCC matched with the various products that are on sale through the shopping mall site, and builds up a database of marketer identification codes, marketer registration, UCC information on the marketers, product sale details of the marketers, fee calculation situations, marketer contract conditions, and so on. The UCC information manager 16 functions to manage information about the various pieces of UCC produced by the marketers, and builds up a database of UCC identification codes of the UCC, and the marketers who produce the UCC. The settlement information manager 17 builds up a database of information associated with payment of the product when a purchase request is made by the buyer terminal 20, information about the marketer who offers the UCC associated with the product, information about calculation of fees to be paid to the marketer, and so on. The authenticator 18 performs authentication on the buyer or marketer who makes attempt to access the shopping mall managing system, and builds up a database of information indicating whether or not the UCC carried by the marketer has the soundness, copyright related information, and so on. The controller 12 controls the functions of the interface and the entities 13 through 18. Meanwhile, the functions of the shopping mall managing system 10 having the aforementioned configuration will be described in detail with reference to FIGS. 2 through 10.

The buyer terminal 20 is a terminal, such as a personal computer, a wired laptop computer, a wireless laptop computer, a personal digital assistant (PDA), etc., that can get access to the shopping mall managing system 10 through the wired or wireless network, and is used by the user (buyer) who wants to purchase the product provided from the shopping mall managing system 10.

The marketer terminal 30 is a terminal that is used by the user (marketer) who is registered as the marketer with the shopping mall managing system 10. The marketer can carry the UCC on the UCC preview servicing system 40 or the shopping mall managing system 10 using the marketer terminal 30.

The UCC preview servicing system 40 is a system with which the UCC produced by the marketer is registered and which provides the registered UCC to the buyer terminal 20 accessed through the network. The UCC preview servicing system 40 includes all systems capable of previewing the UCC including a system intended to preview the UCC. In other words, the UCC preview servicing system 40 can includes various portal sites (Daum, Naver, Yahoo, etc.), personal homepages, personal blogs, etc. through which the UCC preview service is provided.

FIG. 2 is a flowchart illustrating an embodiment for explaining a method of managing a shopping mall site according to the present invention.

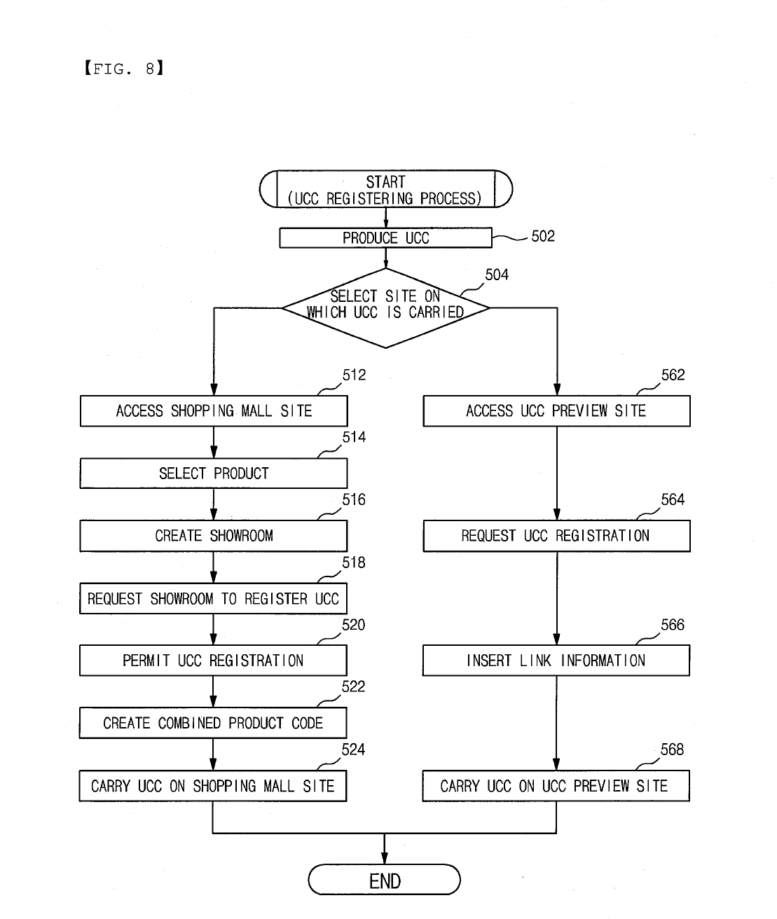

In order to apply the method of managing a shopping mall site according to the present invention, first, the marketer information must be registered with and managed by the shopping mall managing system 10 (S400). In other words, a person who purchases a product at the shopping mall managing system 10 and then intends to advertise excellence of the product to the other buyers, a person who intends to make a profit distributed depending on the advertisement of the products that are on sale at the shopping mall managing system 10 regardless of the purchase of the product, and a person who is requested for the advertisement of the shopping mall or the product by the manager of the shopping mall managing system 10, get access to the shopping mall managing system 10 through the marketer terminal 30, and then provide information about, for instance, their own personal information to the shopping mall managing system 10, so that they are registered as the marketers of the shopping mall managing system 10. In this manner, a process of registering the marketer will be described in detail with reference to FIG. 7.

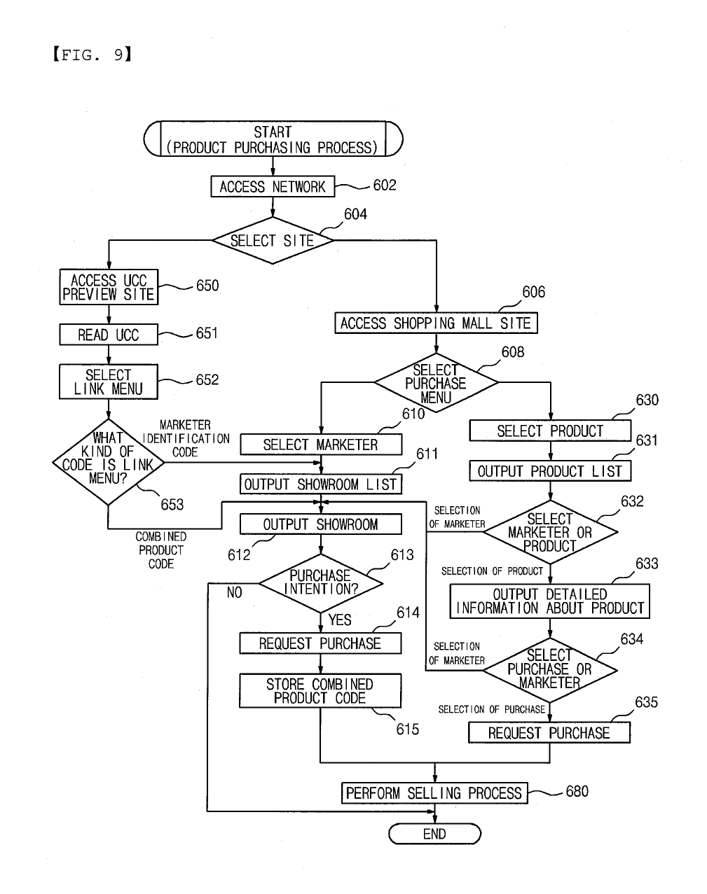

The marketer registered with the shopping mall managing system 10 (hereinafter, simply referred to as “marketer”) produces various pieces of UCC using the marketer terminal 30, and then registers and carries the UCC with and on the UCC preview servicing system 40 or the shopping mall managing system 10 (S500). At this time, the marketer registers the UCC by linking a marketer identification code and a basic product code, which is assigned to him/her, with the UCC. Meanwhile, in addition to these codes, the marketer who wants to register the UCC with the UCC preview servicing system 40 must make a link together with an address of the shopping mall site of the shopping mall managing system such that the buyers can get access to the shopping mall managing system 10 through the UCC. This UCC registering process will be described in detail with reference to FIG. 8.

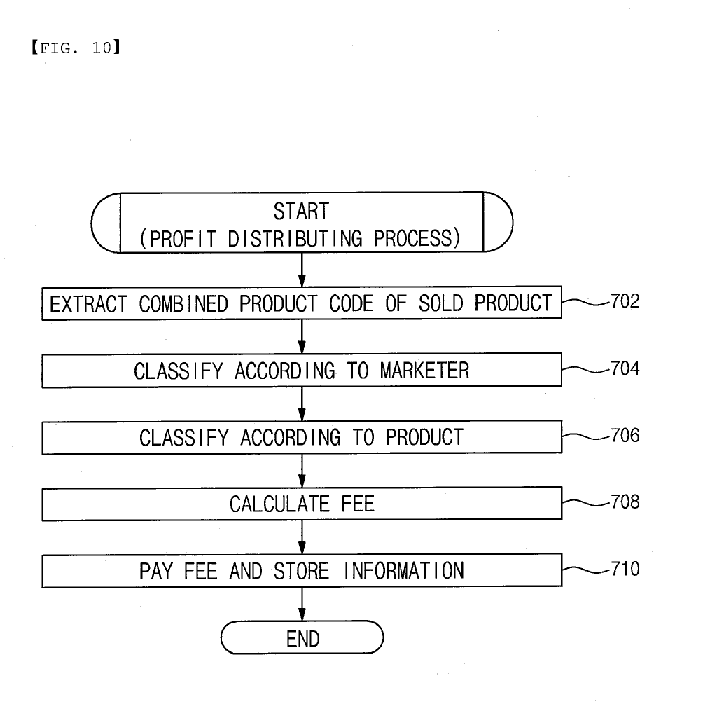

In the state in which the marketer registration and the UCC registration are conducted as described above, the buyer can read the UCC provided by the shopping mall managing system and the UCC preview servicing system, and then purchase the product using the marketer information or the UCC (S600). The aforementioned process of purchasing the product will be described in detail with reference to FIG. 9.

In the case in which buyer reads the UCC to purchase the product or purchases the product using the marketer information, the settlement information manager 17 of the shopping mall managing system 10 analyzes the marketer identification code of the marketer producing the UCC or the marketer identification code that is directly input, and then distributes a profit obtained by selling the product to the marketer confirmed by the analysis (S700). The aforementioned process of distributing the profit will be described in detail with reference to FIG. 10.

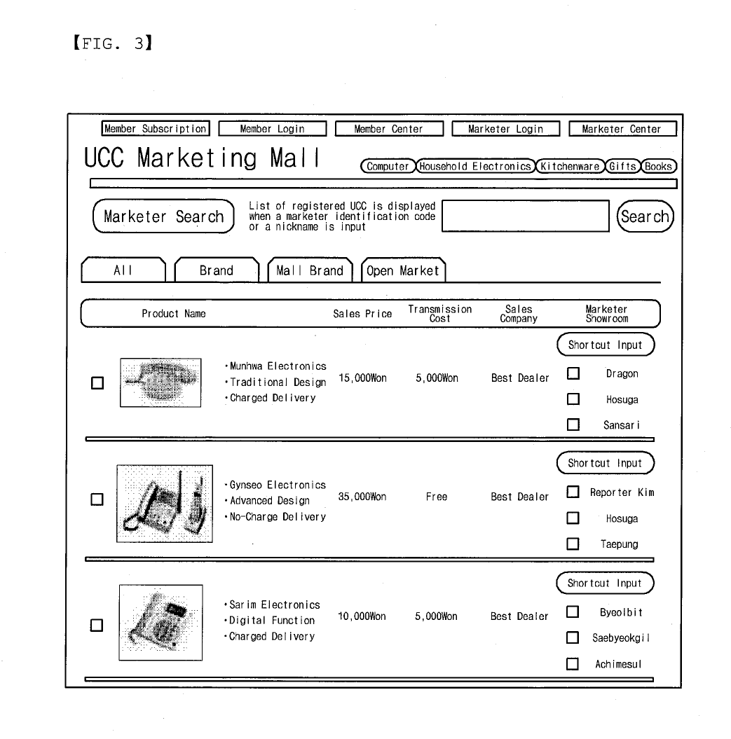

FIGS. 3 through 6 illustrate various formats of a screen and a code applied to the present invention.

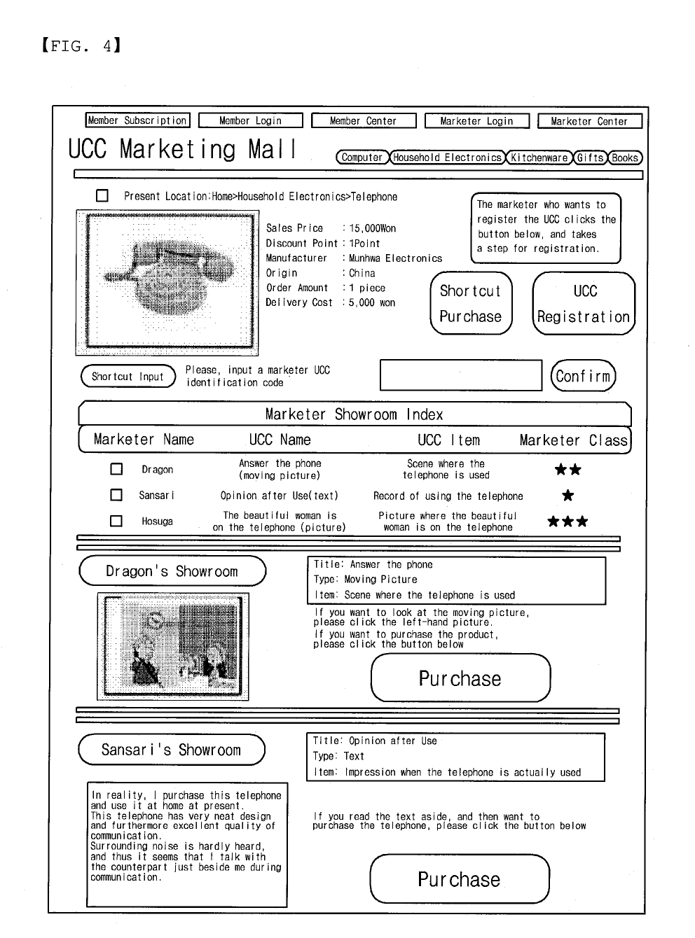

First, FIGS. 3 and 4 illustrate one example of a screen provided at a shopping mall site managed through the shopping mall managing system 10. Specifically, FIG. 3 illustrates a screen through which a buyer can read basic information about various products or about marketers, and FIG. 4 illustrates a screen through which a buyer can read information about marketers who register UCC associated with products and about showrooms when a specific product (e.g. a telephone produced from a Munhwa Electronic company) is selected in FIG. 3. Descriptions of FIGS. 3 and 4 will be supplemented in the description of FIG. 9.

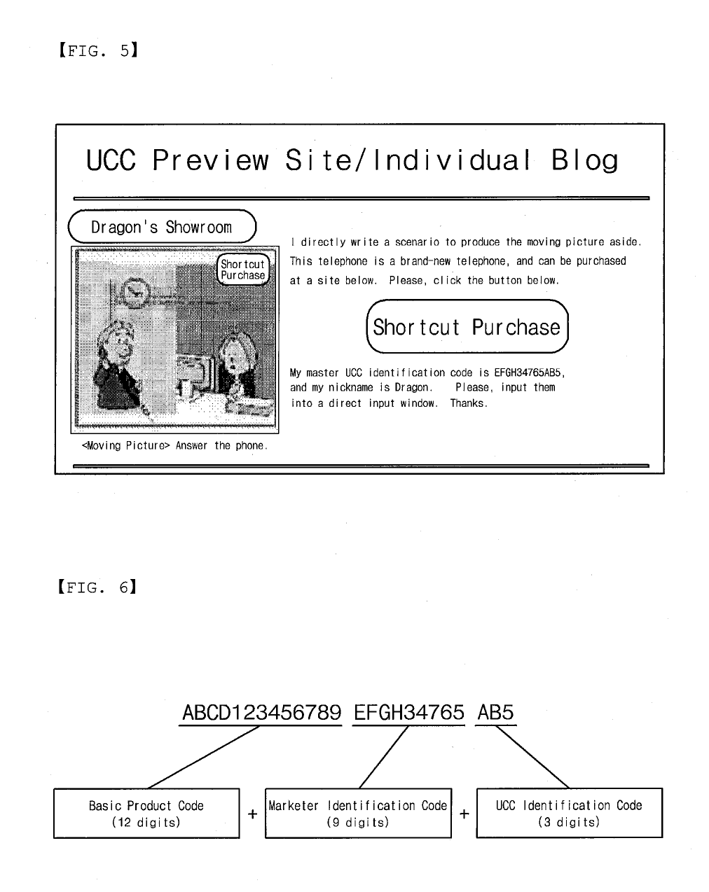

Next, FIG. 5 illustrates one example of a screen provided at a shopping mall site managed through the UCC preview servicing system 40. The user, who visits the UCC preview servicing system to read the UCC registered by the marketer, can select the UCC or a separately linked menu, get access to the shopping mall site managed through the shopping mall managing system, and then purchase a desired product. A description of FIG. 5 will be supplemented in the description of FIG. 9, as in FIGS. 3 and 4.

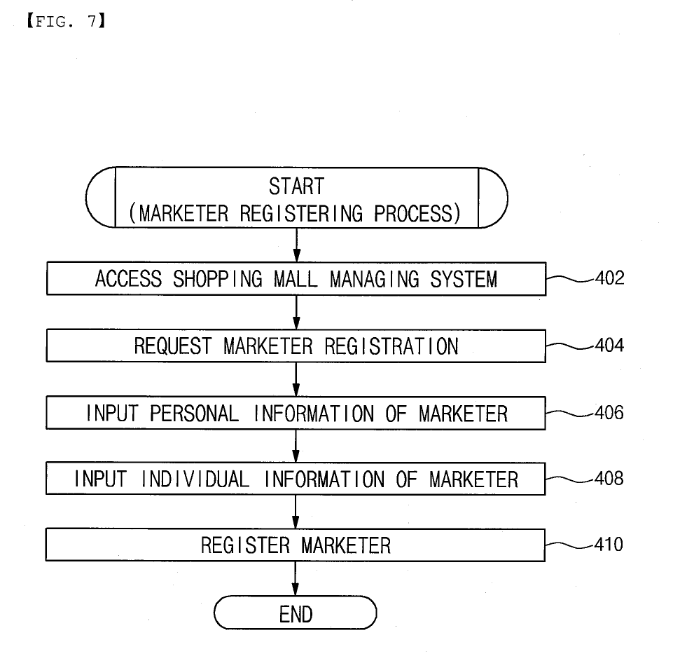

Subsequently, FIG. 6 illustrates a combined product code, which is again divided into a basic product code, a marketer identification code, and a UCC identification code. In other words, the combined product code refers to information in which marketer information, UCC information and product information are joined with each other. Meanwhile, a marketer UCC code in which only both the marketer identification code and the UCC identification code are joined with each other can be used as a code different from the combined product code. These codes are used in all the processes of the present invention, namely the marketer registering process S400, the UCC registering process S500, the product purchasing process S600, and the profit distributing process S700, and will be supplementarily described when these processes are described.

FIG. 7 is a detailed flowchart illustrating an embodiment of a marketer registering process applied to the present invention, and particularly the marketer registering process S400 described in FIG. 2.

A person (a requester) who wants to act as the marketer of the shopping mall managing system 10 gets access to the shopping mall managing system 10 using his/her own marketer terminal 30 (S402), and makes an application for marketer registration at the shopping mall site managed through the shopping mall managing system 10 (S404).

The controller 12 of the shopping mall managing system 10 receives personal information (name, social security number, etc.) for the purpose of identification of the requester to perform a procedure for identification, and receives settlement related information (account number, etc.) such as a fee receiving method to store it in the marketer information manager 15 (S406).

Further, the controller 12 receives individual information such as a marketer identification, a marketer password, a marketer nickname, etc. from the requester, and then stores it in the marketer information manager 15 (S408).

Also, the controller 12 creates the marketer identification code given in the description of FIG. 6, calculates a marketer class of the requester, matches the marketer identification code and the marketer class with the personal information and the individual information of the requester, and stores it in the marketer information manager 15. Thus, the requester is registered as the marketer of the shopping mall managing system through this process (S410).

The marketer identification code can be created in various formats. However, the present invention has described taking the marketer identification code in which four English alphabets and five numbers are combined with each other by way of an example as illustrated in FIG. 6.

FIG. 8 is a detailed flowchart illustrating an embodiment of an UCC registering process applied to the present invention, and particularly the UCC registering process S500 described in FIG. 2.

The marketer going through the marketer registering process S400 produces UCC using his/her own marketer terminal 30 (S502). The UCC may be a moving picture produced using a camcorder as well as a photograph produced using a digital camera. Of course, the UCC may include pictures, flashes, voice, etc. produced using various tools. Further, the UCC applied to the present invention may include a text created by the user. Further, the items of the UCC may be relevant or irrelevant to the products which the marketer wants to advertise.

The marketer producing the UCC selects a site on which the UCC is to be carried (S504). The site on which the UCC is to be carried may include a UCC preview site such as various portal sites (Daum, Naver, Yahoo, etc.), personal homepages, and personal blogs, or a shopping mall site managed by the shopping mall managing system. However, the present invention is adapted to be realized on the basis of the UCC carried on the shopping mall site. Thus, a method of carrying the UCC on the shopping mall site will be first described below, and then a method of carrying the UCC on the UCC preview site will be described. The UCC preview site is a site managed by the UCC preview servicing system 40, and the shopping mall site is a site managed by the shopping mall managing system 10.

The marketer who wants to carry the UCC on the shopping mall site gets access to the shopping mall site using the marketer terminal 30 (S512), goes through a marketer login process, and then selects the product which the marketer wants to advertise (S514).

When the marketer makes an application for creation of a showroom of the product, the controller 12 creates the showroom linked with the product, and provides menus capable of registering the UCC (S516).

When the marketer makes an application for registration of the UCC produced in person by himself/herself using the menus provided from the showroom, the controller 12 stores information about the UCC in the UCC information manager 16, and informs a manager (or a monitor agent) that the application was made for the UCC registration (S518).

The manager searches for the items of the UCC and keywords through an output (not shown) of the shopping mall managing system 10, thereby checking whether or not the items of the UCC are sound. If the items of the UCC are sound, information permitting the UCC registration is input through an input (not shown) of the shopping mall managing system 10 (S520).

When the information permitting the UCC registration is input, the controller 12 creates both a UCC identification code associated with the UCC and a combined product code in which the UCC identification code, the marketer identification code, and the basic product code of the product linked with the UCC, and then stores these codes in the product information manager 14, the marketer information manager 15, and the UCC information manager 16 (S522).

Further, the controller 12 carries the UCC on the shopping mall site using the information of the shopping mall manager 13 and the other managers 14, 15 and 16 (S524).

Meanwhile, although the present invention has been described that, when the application is made for the UCC registration (S518), the manager (monitor agent) determines whether or not the UCC is sound, and permits the UCC registration (S520), and then the controller creates the combined product code (S522), and carries the UCC (S524), the present invention is not limited to this description.

Thus, the process (S520) of permitting the UCC registration may be conducted after the UCC is carried on the shopping mall site. In other words, when the marketer makes an application for the UCC registration (S518), the controller 12 creates the combined product code without delay (S522), and carries it on the shopping mall site (S524), and then informs the manager of the registration. Thereafter, when a formal permission signal of the registration is input, the controller 12 conducts the process (S520) of permitting the UCC registration. When a signal of making a request to cancel the registration is input, the controller 12 deletes the UCC from the shopping mall site.

Meanwhile, the marketer who wants to carry the UCC on the UCC preview site (S504) gets access to the UCC preview site using the marketer terminal 30 (S562).

The marketer makes an application for the UCC registration on the basis of the method provided by the UCC preview site (S564).

In the process of registering the UCC with the UCC preview site, the marketer registers various pieces of link information, in which the buyers can get access to the shopping mall managing system 10 through the UCC, with the UCC preview site together with the UCC (S566).

According to a first method of registering the link information with the UCC preview site together with the UCC, the marketer links his/her own marketer identification code stored in the marketer information manager 15 and the address information of the shopping mall site with the UCC, and registers them with the UCC preview site. In other words, the UCC itself which is to be carried on the UCC preview site or another menu which is to be output to the screen of the UCC preview site on which the UCC is to be carried are allowed to be linked with the marketer identification code and the address information of the shopping mall site, so that the buyer selects the UCC or the menu (hereinafter, collectively referred to as “link menu”), gets access to the shopping mall site, and reads the information about various showrooms produced by the marketer.

According to a second method, the marketer links the combined product code stored in the marketer information manager 15 and the address information of the shopping mall site with the UCC, and registers them with the UCC preview site. In other words, the UCC itself which is to be carried on the UCC preview site or another menu which is to be output to the screen of the UCC preview site on which the UCC is to be carried are allowed to be linked with the combined product code and the address information of the shopping mall site, so that the buyer selects the UCC or the menu (hereinafter, collectively referred to as “link menu”), gets access to the shopping mall site, and reads the information about the showroom matched with the product.

The differences between the methods are as follows. In detail, in the case of the first method, the buyer can read all the showrooms of the marketer which are managed by the shopping mall managing system 10. However, in the case of the second method, the buyer can read only one showroom matched with a specific product among all the showrooms of the marketer which are managed by the shopping mall managing system 10. Namely, the marketer can advertise the whole showrooms which are produced by himself/herself through the marketer identification code linked with the UCC, or only the showroom for the specific product through the combined product code.

Meanwhile, in order to make this configuration possible, the shopping mall managing system 10 provides information a link through which the address information of the shopping mall site is joined with at least one of the marketer identification code, the combined product code, and the UCC identification code. Thereby, the marketer can copy the link information, and directly use it at the UCC preview site.

The marketer can register the UCC and the various pieces of link information with the UCC preview site through the aforementioned processes S562 through S566, and carries the UCC and the various link menus on the UCC preview site (S568).

FIG. 9 is a detailed flowchart illustrating an embodiment of a product purchasing process applied to the present invention, and particularly the product purchasing process S600 described in FIG. 2.

According to the present invention, there are generally two methods in which the buyer can purchase the product provided by the shopping mall site.

In the case of the first method, the buyer directly reads the UCC provided by the shopping mall site and the purchase the product. In other words, the first method is adapted to register online the marketer who intends to receive a predetermined fee when the product is sold by carrying the UCC promoting the sale of the product on the shopping mall site, make the showrooms such that the marketers can carry the UCC on the shopping mall site, and distribute the profit obtained by selling the product to the marketers of the showrooms at which the buyers directly select and purchase the products in an previously prescribed manner.

In the case of the second method, the marketer carries the link menu, with which information on an address of the showroom is linked, on the UCC preview site in addition to the shopping mall site along with a recommendatory content of a specific product, and the buyer moves to the showroom of the shopping mall site through the link menu so as to purchase the product. Consequently, in order to purchase the product using the second method, the buyer must get access to the shopping mall site.

In other words, since the marketers who want to use the present invention can receive a predetermined profit obtained by selling the product only when the product is selected by carrying the UCC attracting buyer's attention compared to the other pieces of UCC, they will make effort to carry a good quality of UCC. Thus, the present invention can contribute to the production of good UCC. As such, the present invention can not only provide the product advertisement to the buyers through the good UCC, but also increase the product sale of the shopping mall site by providing the link through which the products can be directly purchased. Further, the present invention carries various pieces of UCC according to classes divided by an amount of the fee which each marketer receives, so that it enables the marketers to induce more brisk marketing activity. Also, the present invention allows the marketers to exposes recommendatory products to various UCC preview sites through the UCC as much as possible, so that the marketers can obtain higher profit.

The aforementioned product purchasing process will be described below in greater detail with reference to FIG. 9.

The buyer gets access to the network using the buyer terminal 20 (S602).

The buyer, who gets access to the network, can select one of the shopping mall site and the UCC preview site (S604).

The buyer gets access to the shopping mall site by the selection (S606), and then can select at least one of various purchase menus provided by the shopping mall site (S608). The purchase menus include a marketer selection menu capable of selecting a desired marketer, a product selection menu capable of selecting a desired product, a marketer product menu capable of selecting a specific product advertised by a specific marketer, and so on.

Thus, the buyer can select any one of the purchase menus (S608).

When the buyer selects the marketer selection menu from the purchase menus, the controller can extract information about the marketers which is stored in the marketer information manager 15, and transmit the extracted information to the buyer terminal 20. At this time, the buyer can make a request for information about all the marketers, and select one marketer from the marketers recorded on a marketer list. Otherwise, the buyer can input the name, marketer identification code or nickname of a desired marketer into a marketer search window, and select the desired marketer (S610). In other words, the buyer gets access to the shopping mall site, searches for the desired marketer regardless of the product, and selects the desired marketer. For example, in the screen illustrated in FIG. 3, the buyer can input the marketer identification code, the marketer name, or the marketer nickname into the search window, and directly search for the desired marketer. In addition to this method, the buyer can select the desired marketer from the marketers recorded on the marketer list provided through, for instance, a separate marketer selection menu.

When the desired marketer is selected through the marketer selecting process S610, the controller 12 extracts the UCC identification codes linked with the marketer identification code of the marketer from the UCC information manager 16, and extracts the basic product codes linked with the UCC identification codes. Then, the controller 12 outputs at least one showroom list on the basis of the combined product code consisting of the marketer identification code, the UCC identification codes and the product identification codes (S611). In detail, in the case in which the marketer registers only one product with respect to one UCC, only one showroom is output for the product. In contrast, in the case in which the marketer registers a plurality of products with respect to the respective pieces of UCC, the showrooms corresponding to the number of UCC can be output. Further, in the case in which a plurality of UCC is registered for one product, or in the case in which one UCC is registered for a plurality of products, a list of the showrooms created for the respective pieces of UCC or the respective products can be output. In other words, the marketer can create the showroom for each individual product or each UCC. However, the duplicated UCC is output for a plurality of products, the buyers may be fed up with this situation. Thus, the showroom is preferably created such that one UCC can be linked with respect to one product.

When the buyer checks the information on each showroom of the showroom list, and then selects a specific showroom, the controller 12 outputs the specific showroom (S612). More specifically, the showroom provides the items of the UCC and simple information about the product linked with the corresponding showroom, so that the buyer selects the specific showroom from the showrooms of the showroom list according to either the UCC which the buyer wants to read or the information about the product which the buyer wants to purchase.

In the case in which the buyer selecting the specific showroom has an intention of purchasing the product provided by the showroom (S613), the buyer makes a purchase request (S614). However, in the case in which the buyer has no intention of purchasing the product, all the processes come to an end. There are various intentions which the buyer has in order to purchase the product through the showroom. For example, the buyer may purchase the product because the product is recommended by the marketer creating the showroom, because he/she satisfies the product advertisement through the UCC provided through the showroom, or because he/she wants to compensate the marketer for good UCC provided through the showroom.

In the case in which the buyer makes a request to purchase the product through the purchase intention selecting process S613 (S614), the controller 12 stores the combined product code matched with the product in the settlement information manager 17 (S615), and performs a process of selling the product (S680). The selling process refers to a general procedure performed when a request is made to purchase the product at a general shopping mall site, namely a procedure of paying for the product, informing whether or not the product is delivered, checking whether or not the product is received, and so on.

Meanwhile, in the process S608 of selecting one of the purchase menus, when the buyer selects the product selection menu, the controller 12 extracts the information about the products which is stored in the product information manager 14, and transmits the extracted information to the buyer terminal 20. At this time, the buyer can request the information about all the products to select one product from the products listed in the information, or input the name of a specific product desired by himself/herself into a product search window, and then select the desired product (S630).

When one product (e.g. a telephone) is selected through the product selecting process S630, the controller 12 extracts the basic product codes of the products corresponding to a category of the products from the product information manager 14, and extracts marketer identification codes and the UCC identification codes linked with the respective basic product codes from the marketer information manager 15 and the UCC information manager 16. Meanwhile, the controller 12 outputs a product list on which simple product information about the extracted products and the information about the marketers creating the showrooms for the products are indicated (S631). For example, in the screen illustrated in FIG. 3, when the buyer selects the telephone from the product selection menu, a list of the products corresponding to the telephone is output. Further, in the product list of FIG. 3, a list of the marketers (Dragon, Hosuga, Sansari, etc.) carrying the UCC for the respective products (e.g. a telephone produced from a Munhwa Electronic company) is output.

The buyer can check the information about the products of the product list illustrated in FIG. 3 to select a specific product, or select a specific marketer linked with a specific product (S632).

In the case in which the specific marketer is selected in the selecting process S632, the controller 12 outputs the showroom of the marketer for the product. The following processes are equal to the showroom outputting process S612 described above.

In the case in which the specific product is selected in the selecting process S632, the controller 12 outputs a screen (FIG. 4) in which the detailed information about the product (e.g. a telephone produced from a Munhwa Electronic company) (S633). This screen (FIG. 4) can include the list of the marketers (Dragon, Hosuga, Sansari, etc.) creating the showrooms associated with the product, or the showrooms produced by the marketers.

The buyer can immediately select one of the purchase menus when reading the detailed information about the product to have a purchase intention (S634), and make a request to purchase the product (S635). Otherwise, the buyer can read the UCC provided by the showroom selected in the purchase requesting process S634, and then purchase the product at the showroom. In other words, in the case in which the list of the marketers is provided through the screen, the buyer can select a specific marketer, read the UCC at the showroom provided for the product, and then purchase the product. This process is equal to the process of purchasing the product through the showroom outputting process S612.

Meanwhile, in the case in which the showrooms are provided for the products through the screen, the buyer can read the UCC provided at the showroom, and then purchase the product. This process is also equal to the process of purchasing the product through the showroom outputting process S612. However, in the case in which the buyer can immediately select one of the purchase menus (S634) and make a request to purchase the product (S635), the product purchase is irrelevant to the marketer and the UCC. Thus, the selling process proceeds without delay (S680).

In the process S608 of selecting any one from the purchase menus, the buyer directly inputs the combined product code known to himself/herself into the marketer product menu, i.e. the search window, and directly moves to the showroom outputting process S612.

In other words, the buyer can directly receive the combined product code from the marketer or input the combined product code received from the UCC preview site on which the marketer carries the UCC into the search window. When the combined product code is input, the controller 12 outputs the screen obtained in the showroom outputting process S612 to the buyer. The following processes are equal to those described in the showroom outputting process S612.

In the case in which the buyer accessing the network selects the UCC preview site in the site selecting process S604 and thereby gets access to the UCC preview site (S650), the buyer can read various pieces of information provided by the UCC preview site (S651). The UCC preview site may include all the sites in which the UCC can be carried and read. For example, the buyer can select and read one of the UCC which he/she thinks to be fun, the UCC to which he/she pays attention, and the UCC which the marketer carries so as to be suitable to his/her style.

Meanwhile, the buyer can select the link menu provided along with the UCC so as to be able to get access to the shopping mall site (S652). As in the description of FIG. 8, the link menu is created by the marketer in order to induce the buyers to the shopping mall site. As illustrated in FIG. 5, the link menu may be created on a UCC screen itself (e.g. a “shortcut purchase” menu created on a UCC screen), or through a separate menu (e.g. a “shortcut purchase” menu created on a text column) (hereinafter, collectively referred to as “link menu”). In detail, the buyers select the link menu to get access to the shopping mall site during reading the UCC on the basis of various pieces of information provided for the UCC (product advertisement provided by the UCC, various product advertisement phases output together with the UCC, product recommendatory phases of the marketer, etc.) or because of the shopping mall recommended by the marketer.

Here, in the case in which the link menu is made up of the marketer identification code and the address information of the shopping mall site, the buyer is accessed through the showroom list outputting process S611. In the case in which the link menu is made up of the combined product code and the address information of the shopping mall site, the buyer is accessed through the showroom outputting process S612 (S653). The following processes are performed by the showroom list outputting process S611 and the showroom outputting process S612, both of which are described above.

Meanwhile, as described above, after the marketer is registered with the shopping mall site (S400), the marketer can register the UCC with the shopping mall site or the UCC preview site (S500). However, the present invention is not limited to this process. Thus, in the case of the user who is not registered as the marketer with the shopping mall site but is subscribed as a general member, he/she can be registered as the marketer only by requesting the UCC registration and the permission of the marketer registration and by recording the information (account number, etc.). In other words, the user who wants to act as the marketer can be registered as the marketer (S400) and then register the UCC (S500). Further, after or when the user registers the UCC, he/she can be registered as the marketer, thereby acting as the marketer.

FIG. 10 is a detailed flowchart illustrating an embodiment of a profit distributing process applied to the present invention, and particularly the profit distributing process S700 described in FIG. 2.

As described above, in the case in which the buyer makes a request to purchase the product through the purchase intention selecting process S613 (S614), the controller 12 stores the combined product code matched with the product in the settlement information manager 17 (S615). Meanwhile, in the case in which the settlement for distributing the profit must be performed according to the profit distributing process (i.e. the process of determining whether or not the condition under which the profit must be distributed is established) stored in the settlement information manager 17, the controller 12 extracts the combined product codes, the products of which have already been sold, from the settlement information manager 17 (S702).

The controller 12 extracts the marketer identification codes from the extracted combined product codes, and classifies each combined product code according to the marketer (S704).

The controller 12 extracts the product identification codes from the combined product codes classified according to the marketer, and then classifies them according to the product (S706).

The controller 12 calculates a fee to be paid to each marketer using a preset marketer class, a fee rate of each product, and so on (S708). The following Table 1 shows an example of the fee rate according to the product and the marketer class. The controller calculates the fee to be paid by synthesizing the marketer class of the corresponding marketer, the product linked with the UCC, the fee rate according to the marketer class, and so on.

TABLE 1

| Basic Product | Product | | | | |
|---|---|---|---|---|---|
| Code | Name | ★ | ★★ | ★★★ | ★★★★ |
| ABCD123456781 | Telephone1 | 7% | 8% | 9% | 10% |
| ABCD123456782 | Telephone2 | 11% | 12% | 13% | 14% |
| ABCD123456783 | Telephone3 | 5% | 5.5% | 6% | 6.5% |
| ABCD123456784 | Telephone4 | 8% | 10% | 12% | 14% |
| ABCD123456785 | Telephone5 | 10% | 13% | 16% | 19% |

The controller 12 performs the process of paying a corresponding fee to each marketer when the fee is calculated according to the marketer, and stores and manages information about the fee payment in the settlement information manager 17 (S710). The process of paying the fee refers to a process of paying the fee to each marketer online according to the settlement information, and complies with a general process of sending a specific expense to a specific account. Thus, a detailed description thereof will be omitted.

### INDUSTRIAL APPLICABILITY

As described above, the present invention is adapted to establish the shopping mall site capable of carrying the UCC for a specific product, and pay a predetermined fee to the marketer carrying the UCC when the product is purchased after reading the UCC. The present invention enables the person producing the UCC to make efficient use of the UCC as a moneymaking means without being limited to the interest alone, so that it can offer a motive of the UCC production to the UCC producer, and advertise the product to more buyers through the good UCC.

What is claimed is:

1-9. (canceled)

10. A method of managing a shopping mall site applied to a shopping mall service system, the method comprising steps of:
receiving information about a requester, who wants to advertise a product for sale through the shopping mall site by using a user created content (UCC),
registering the requester as a marketer in the shopping mall managing system for managing the shopping mall site,
creating a showroom to display the product for sale by the marketer,
inputting the UCC for advertising the product in the showroom,
setting a marketer code, a basic code for the product, a user code for the UCC,
registering the marketer code, the basic code for the product, the user code for the UCC,
advertising the product for sale and information about the marketer by using the UCC through the shopping mall site,
storing information about sold product regarding the marketer code, user code for the UCC and the basic code for the product, when a buyer made a decision to purchase the product from the buyer terminal, and
paying fees and distributing profits to the marketer, when the profits through the sale of the product is obtained and figured by the shopping mall managing system.

11. The method as claimed in claim 10, wherein the step of registering the requester as the marketer, further comprising sub-steps of:
receiving personal information from the requester to verifying identification, who wants to advertise the product for sale by using UCC,
storing the received personal information about the requester as the marketer; and
storing the code of marketer identification for the requester linked to the personal information.

12. The method as claimed in claim 10, wherein the step of storing the information about the marketer, the product and the UCC, when the buyer purchased the product, further comprising sub-steps of:
providing a purchase menu associated with the product through the shopping mall site;
providing the UCC through a showroom of the marketer selected by the marketer selection menu, when a marketer selection menu is selected as the purchase menus, and receiving a purchase signal of the product linked to the UCC from the buyer terminal;
providing a showroom on which information about the product selected by the product selection menu, when a product selection menu is selected as the purchase menus, and the UCC linked with the product is carried, and receiving the product purchasing signal of the product from the buyer terminal through the showroom;
providing the UCC through the showroom selected by the marketer product menu, when a marketer product menu is selected as the purchase menus, and receiving the product purchase signal of the product linked with the UCC from the buyer terminal; and
performing a selling process according to the purchase request signal, and storing the information about the marketer, the UCC, and the product.

13. The method as claimed in claim 10, wherein the step of distributing the fee and profit, further comprising sub-steps of:
retrieving information about the marketer linked to the sold product code, the UCC code, and the product code;
calculating the fee and profit to share and distribute to the marketer through information about the marketer, the UCC, and the product; and
transferring the calculated fee and shared profit to an account of the marketer.

14. The method as claimed in claim 10, wherein the step of registering the requester as the marketer is further comprising a link menu, which is selectively displayed on a buyer's terminal screen, when the buyer selects the link menu through preview site of the UCC in the shopping mall site.

15. The method as claimed in claim 10, wherein the step of registering the UCC is linked to a link menu, which is created by the marketer and carried on a preview site of the UCC, and a buyer can access to display the registered UCC on his/her terminal through the shopping mall site, when the link menu is selected at the preview site of the UCC.

16. The method as claimed in claim 10, wherein information about the marketer, UCC, and product is managed by the marketer identification code, UCC identification code, basic product code, respectively, when a request for purchasing the product is submitted to linked to the UCC, the shopping mall managing system stores a combined product code including the marketer, UCC, and product identification codes.

17. The method as claimed in claim 10, wherein the shopping mall managing system stores information about the marketer, UCC, product codes for sale, and the sold product associated with information about the marketer, which is stored at least one of a shopping mall manager, a product information manager, a marketer information manager, a UCC information manager, and a settlement information manager.
